(19) United States
(12) Patent Application Publication
(10) Pub. No.: US 2011/0103841 A1
(43) Pub. Date: May 5, 2011

(54) Developer, developer cartridge, developing unit, and image forming apparatus

(76) Inventor: Kenji Koido, Tokyo (JP)

(21) Appl. No.: 12/929,305

(22) Filed: Jan. 13, 2011

Related U.S. Application Data
(62) Division of application No. 11/647,604, filed on Dec. 29, 2006, now abandoned.

(30) Foreign Application Priority Data
Jan. 6, 2006 (JP) 2006-001348

(51) Int. Cl. G03G 15/08

(52) U.S. Cl. 399/252

(57) ABSTRACT

A developer contains a resin, a coloring agent, and an external additive in an amount of 2.5 to 4.5 weight parts added to the resin in an amount of 100 weight parts resin. The developer has an average volume mean particle diameter in the range of 4.5 to 6.5 μm and a BET specific surface in the range of 2.45 to 3.74 m²/g. The external additive may be silica.

This is a Divisional of U.S. application Ser. No. 11/647,604, filed Dec. 29, 2006, the subject matter of which is incorporated herein by reference.

### BACKGROUND OF THE INVENTION

1. Field of the Invention

The present invention relates to a developer, a developer cartridge, a developing unit, and an image forming apparatus used in a copying machine, a facsimile machine, a printer, or the like.

2. Description of the Related Art

Monochrome printing does not require gloss of printed images, and uses a toner based on a resin that contains a cross-linking agent. The toner release agent contained in toners based on a resin that contains a cross-linking agent is small in quantity and has a high melting point. Therefore, the toner can be subjected to heat treatment to ensure that an external additive is added to toner particles. Adjusting the amount of an external additive to toner provides good durability of the toner. If toner particles have a large volume mean particle diameter, a small amount of an external additive may be added to the toner particles. If toner particles have a small volume mean particle diameter, a large amount of an external additive may be added to the toner particles.

If a large amount of external additive is added to the toner particles, a toner release agent melts on the surfaces of the toner particles and adheres to structural elements of a developing unit, causing filming.

### SUMMARY OF THE INVENTION

An object of the invention is to provide a developer that will not result in filming even if continuous printing is performed.

Another object of the invention is provide a developer cartridge, a developing unit, and an image forming apparatus that use the developer.

A developer contains a resin, a coloring agent, and an external additive in an amount of 2.5 to 4.5 weight parts added to the resin in an amount of 100 weight parts resin. The developer has an average volume mean particle diameter in the range of 4.5 to 6.5 μm and a BET specific surface in the range of 2.45 to 3.74 m²/g. The external additive may be silica.

The external additive is silica.

A developer cartridge holds the developer.

An image forming mechanism uses the aforementioned developer. A chamber holds the developer. An image bearing body includes a surface that runs at a linear speed in the range of 50-300 mm/s. A charging member charges a surface of said image bearing body. An exposing member illuminates the charged surface of the image bearing body to form an electrostatic latent image on the image bearing body. A developer bearing body supplies the developer to the electrostatic latent image to develop the electrostatic latent image into a visible image. A resilient member is disposed upstream of the charging member with respect to rotation of the image bearing body and downstream of said developer bearing body, the resilient member being in resilient contact with said image bearing body such that said resilient member exerts a line pressure in the range of 0.8-2.4 gf/mm on said image bearing body.

The developer has an average roundness in the range of 0.900-0.940.

An image forming apparatus incorporates the image forming mechanism. The image forming apparatus includes a transfer section that transfers the visible image onto a recording medium; and a fixing section that fixes the visible image into a permanent image.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1A illustrates toner having a relatively large BET specific surface;

FIG. 1B illustrates toner having a relatively small BET specific surface;

FIG. 2 is a cross-sectional side view illustrating the configuration of an image forming apparatus;

FIG. 3 illustrates an image forming section;

FIG. 4 is an expanded view illustrating a pertinent portion of the image forming section;

FIG. 5 illustrates a pertinent portion of a toner cartridge;

FIG. 6 is a cross-sectional side view of a fixing unit; and

FIG. 7 illustrates how a line pressure applied by the cleaning blade on the photoconductive drum is calculated.

### DETAILED DESCRIPTION OF THE INVENTION

### First Embodiment

### Image Forming Apparatus

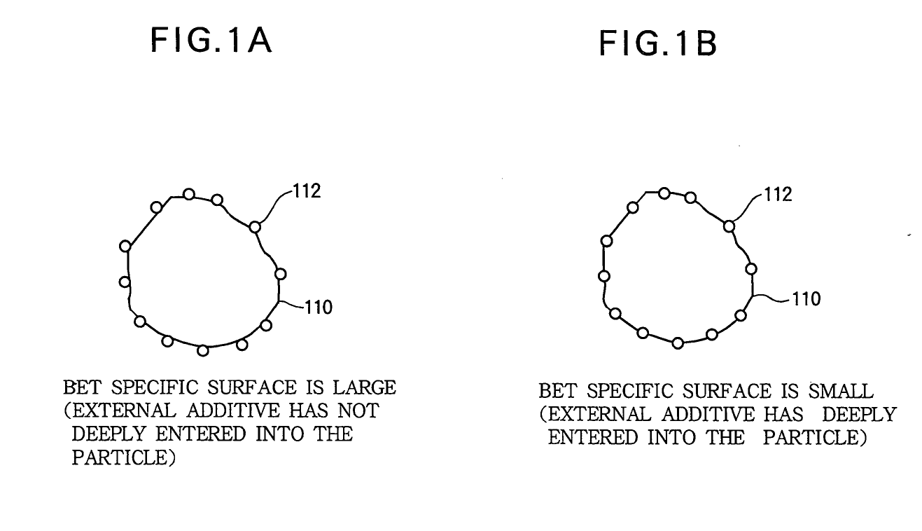

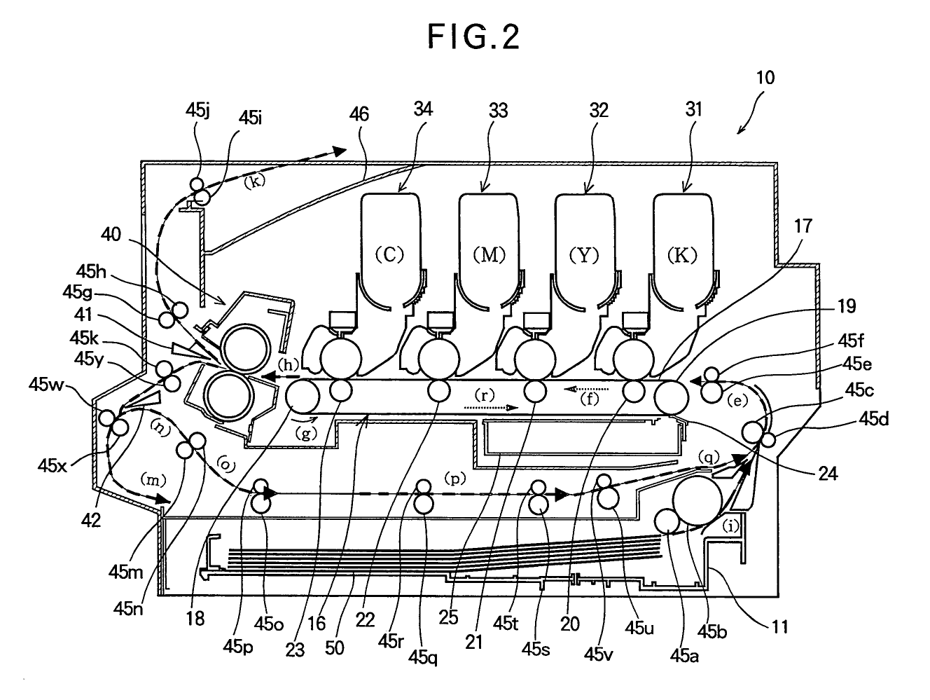

FIG. 1A illustrates a particle of developer according to the present invention when the developer has a large BET specific surface. FIG. 1B illustrates a particle of developer according to the present invention when the developer has a small BET specific surface. FIG. 2 is a cross-sectional side view illustrating the configuration of an image forming apparatus 10 according to the present invention.

Referring to FIG. 2, the image forming apparatus 10 is a color electrophotographic printer that includes a paper cassette 11, image forming sections 31-34, a transfer unit 16, and a fixing unit 40. The image forming apparatus 10 also includes transport rollers 45a-45x that transport recording paper 50, and guides 41 and 42 that switch a path of the recording paper 50.

The paper cassette 11 holds a stack of the recording paper 50, and is detachably attached into a lower portion of the image forming apparatus 10. The transport rollers 45a and 45b feed the recording paper 50 on a sheet-by-sheet basis in a direction shown by arrow (i) into a transport path. The transport rollers 45c-45d and 45e-45f reduce or eliminate skew of the recording paper 50 before feeding the recording paper 50 further to the image forming section 31.

The image forming sections 31-34 are of the same configuration, and form toner images of different colors, respectively, i.e., black (k), yellow (Y), magenta (M), and cyan (C).

A transfer section 16 includes a transfer belt 17, a drive roller 18, a tension roller 19, transfer rollers 20-23, a cleaning blade 24, and a toner reservoir 25. The transfer belt 17 attracts the recording paper 50 on it by a Coulomb force, and transports the recording paper 50 through the image forming sections 31-34. A drive source, not shown, drives the drive roller 18 in rotation, and the drive roller 18 in turn drives the transfer belt 17 to run. The tension roller 19 cooperates with the drive roller 18 to maintain tension in the transfer belt 17. The transfer rollers 20-23 parallel their corresponding photoconductive drums 101, and transfer toner images onto the recording paper 50 as the recording paper 50 is transported through the respective image forming sections 31-34. The cleaning blade 24 scrapes off the toner remaining on the transfer belt 17. The toner reservoir 25 receives the toner scraped off from the transfer belt 17.

For simplicity only the operation of the image forming section 31 for forming black images will be described, it being understood that the other image forming sections 32-34 may work in a similar fashion.

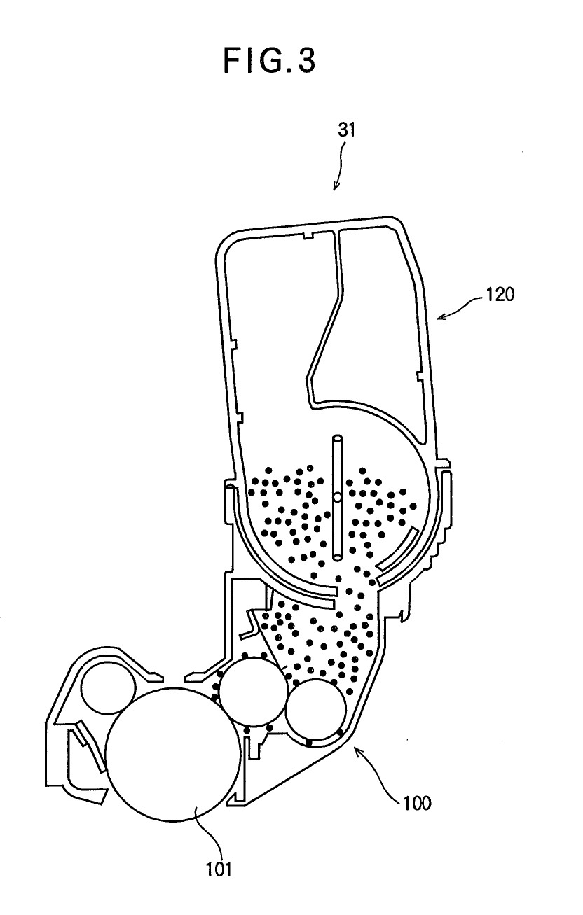

FIG. 3 illustrates the image forming section 31. Referring to FIG. 3, the image forming section 31 includes an image forming mechanism 100 and a toner cartridge 120. The image forming section 31 is detachably attached in position in the image forming apparatus 30. The toner cartridge 120 is detachably attached to the image forming mechanism 100.

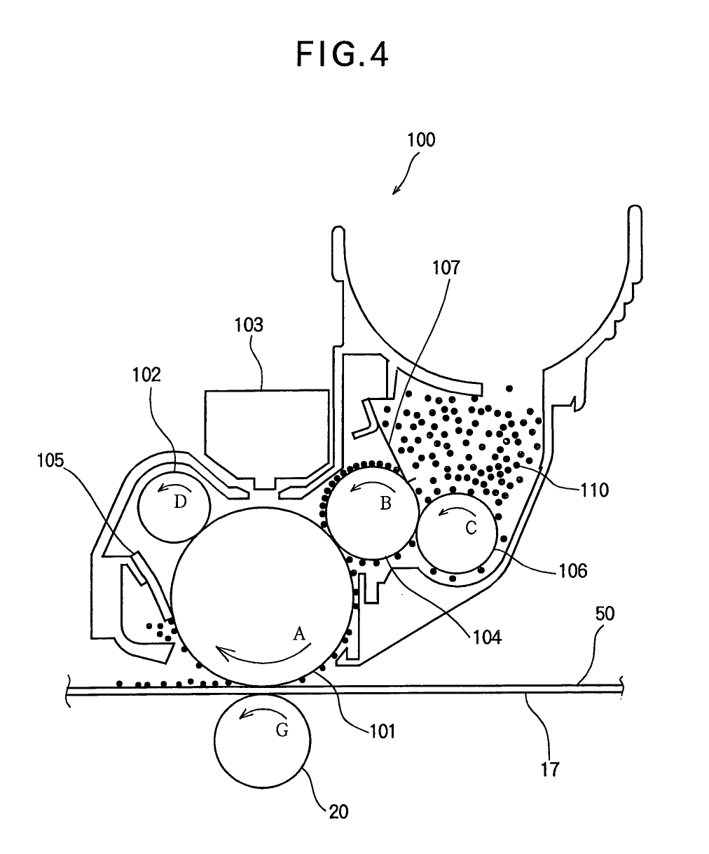

FIG. 4 is an expanded view illustrating a pertinent portion of the image forming section 31. The photoconductive drum 101 has a photoconductive layer formed on an electrically conductive body in the form of an aluminum hollow cylinder. The photoconductive layer is of multilayer construction formed of an organic photoconductive material, and includes a charge generation layer and a charge transport layer. The charging roller 102 includes a metal shaft covered with a layer of semi-conductive epichlorohydrin rubber, and rotates in contact with the photoconductive drum 101. An LED head 103 includes LEDs and a lens array. The image of the LEDs is formed by the lens array on the surface of the photoconductive drum 101.

The developing roller 104 includes a metal shaft covered with a layer of semi-conductive urethane rubber, and rotates in contact with the photoconductive drum 101. A supplying roller 106 includes a metal shaft covered with a layer of semi-conductive foamed silicone sponge. The supplying roller 106 rotates in contact with the developing roller 104 such that the circumferential surface of the supplying roller 106 slides on the circumferential surface of the developing roller 104. Toner 110 contains polyester resin as a binding resin, and a charge control agent, a toner release agent, a coloring agent as internal additives, and silica fine powder as an external additive. A developing blade 107 is formed of stainless steel, and is in pressure contact with the circumferential surface of the developing roller 104 to form a thin layer of toner on the developing roller 104. A cleaning blade 105 is formed of urethane rubber, and is in pressure contact with the circumferential surface of the photoconductive drum 101 to collect residual toner from the photoconductive drum 101.

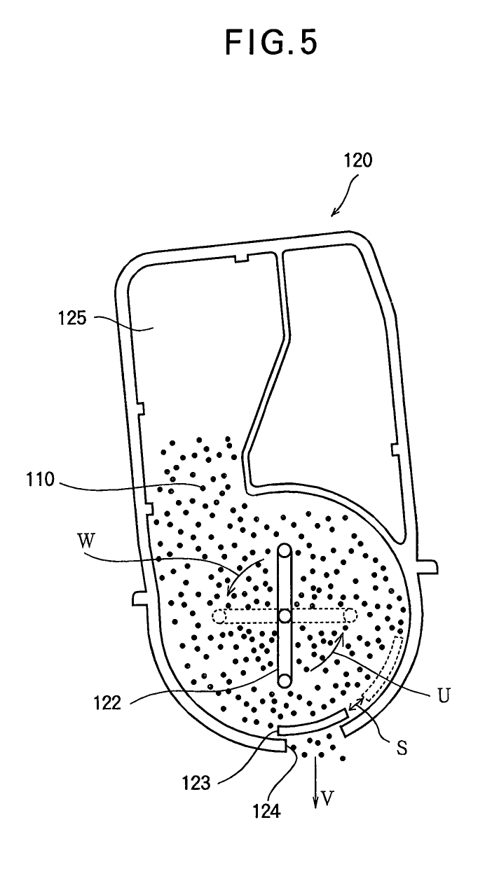

FIG. 5 illustrates a pertinent portion of the toner cartridge 120. The toner cartridge 120 extends in a longitudinal direction (extending in a direction away from the observer) and includes a toner chamber 125. An agitator 122 is rotatably supported in the toner chamber 125, and extends in the longitudinal direction. The agitator 122 rotates in a direction shown by arrow W. The toner chamber 125 is formed with an opening 124 in its bottom wall. A shutter 123 is slidably supported on the bottom wall to open and close the opening 124.

Referring back to FIG. 2, as the recording paper 50 advances in a direction shown by arrow (f) through the respective image forming sections 31-34, toner images of corresponding colors are transferred onto the recording paper 50 one over the other in registration. Then, the recording paper 50 advances in a direction shown by arrow (h) to the fixing unit 40.

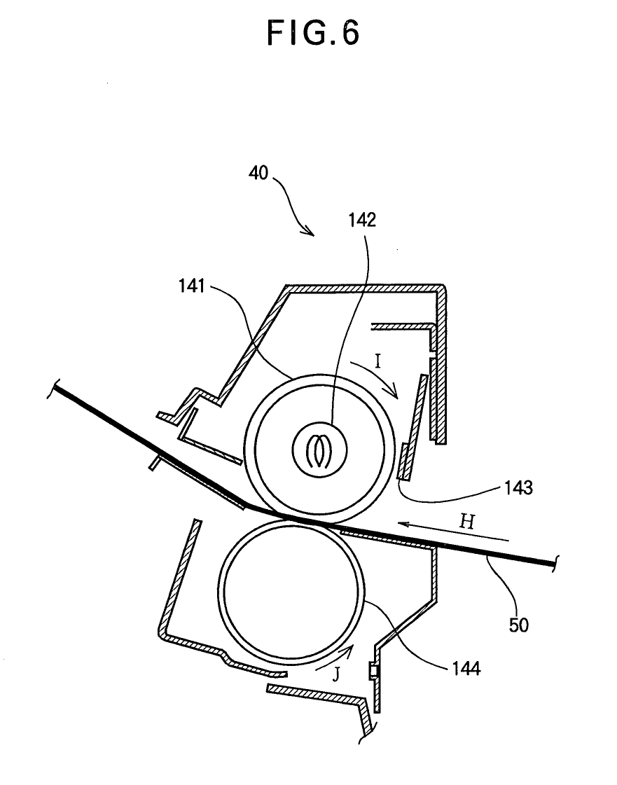

FIG. 6 is a cross-sectional side view of the fixing unit 40. The fixing unit 40 includes a heat roller 141 that rotates in a direction shown by arrow I, a pressure roller 144 that rotates in a direction shown by arrow J, a thermistor 143, and a heater 142 (e.g., halogen lamp). The recording paper 50 advances in a direction shown by arrow H. The heat roller 141 includes an aluminum hollow cylinder covered with a heat resistant resilient layer such as silicone rubber. The heat resistant resilient layer is covered with a tube of tetrafluoride ethylene-per-fluoroalkylvinylether resin (PFA), and incorporates the heater 142.

The pressure roller 144 includes an aluminum core covered with a heat-resistant resilient-layer of silicone rubber which in turn is covered with a tube of PFA. The thermistor 143 is disposed in proximity to the heat roller 141, and detects the temperature of the surface of the heat roller 141. The output of the thermistor 143 is sent to a temperature controlling means, not shown, which in turn controls the heater 142 to turn on and off according to the output of the thermistor 143, so that the surface of the heat roller 141 is at a predetermined temperature.

The image forming process of the image forming apparatus 10 will be described.

Referring back to FIG. 4, the photoconductive drum 101 rotates at a predetermined rotational speed in a direction shown by arrow A. The charging roller 102 rotates in contact with the photoconductive drum 101 in a direction shown by arrow D to uniformly charge the entire circumferential surface of the photoconductive drum 101. The LED head 103 illuminates the charged surface of the photoconductive drum 101 in accordance with print data. The charges in illuminated areas are dissipated to form an electrostatic latent image as a whole.

After the toner cartridge 120 has been attached to the image forming mechanism 100, when the user operates a lever, not shown, the shutter 123 of the toner cartridge 120 in FIG. 5 slides in the direction shown by arrow S to open the opening 124 formed in the bottom wall of the toner chamber 125. Thus, the toner 110 falls through the opening 124 in a direction shown by arrow V into the image forming mechanism 100. A high voltage is applied to the toner supplying roller 106 and the toner supplying roller 106 rotates in a direction shown by arrow C to supply the toner 110 to the developing roller 104.

The developing roller 104 is in intimate contact with the toner supplying roller 106. A high voltage is applied to the developing roller 104. The developing roller 104 attracts the toner supplied from the toner supplying roller 106, and rotates in a direction shown by arrow B to transport the toner 110. As the developing roller 104 rotates, the developing blade 107 forms a thin layer of the toner 110 having a uniform thickness on the developing roller 104.

A high bias voltage is applied across an electrically conductive shaft of the photoconductive drum 101 and the developing roller 104, an electric field is developed across the photoconductive drum 101 and the developing roller 104. The toner 110 on the developing roller 104 moves from the developing roller 104 to the photoconductive drum 101 by the Coulomb force, thereby developing the electrostatic latent image into a toner image.

Referring back to FIG. 2, the recording paper 50 held in the paper cassette 11 is advanced in the (i) direction on a page-by-page basis by the transport rollers 45a and 45b. The recording paper 50 is further advanced by the transport rollers 45c and 45d, and 45e and 45f along the transport path in the (e) direction. The recording paper 50 is then advanced to the transfer belt 17 that is driven by the drive roller 18 to run in the (f) direction. The previously mentioned developing process begins at a timing that the recording paper 50 is advanced by the transport roller 45e and 45f in the (e) direction.

Referring back to FIG. 4, the transfer belt 17 is sandwiched between the photoconductive drum 101 and the transfer roller 20. A high voltage is applied to the transfer roller 20. As the recording paper 50 passes through a transfer point defined between the photoconductive drum 101 and the transfer roller 20, the toner image is transferred onto the recording paper 50 by the Coulomb force.

The recording paper 50 further advances in the (f) direction through the respective transfer points such that yellow, magenta, and cyan toner images are transferred in sequence onto the recording paper 50 one over the other in registration. The recording paper 50 is further advanced to the fixing unit 40.

Referring to FIG. 6, the recording paper 50 having the toner images of the respective colors enters the fixing unit 40. As the recording paper 50 passes through a fixing point defined between the heat roller 141 and the pressure roller 144, the toner images are fused into the recording paper 50 by pressure and heat.

After fixing, the recording paper 50 is further transported by the transport rollers 45g and 45h and transport rollers 45i and 45j in the (k) direction onto the stacker 46.

Referring to FIG. 4, some toner may remain on the photoconductive drum 101 after transfer. The cleaning blade 105 removes the residual toner from the photoconductive drum 101. The width of the cleaning blade 105 spans across the entire length of the photoconductive drum 101 that rotates about a rotational axis. The cleaning blade 105 is fixed at its base portion to a rigid supporting plate, and is in contact with the circumferential surface of the photoconductive drum 101. As the photoconductive drum 101 rotates, the cleaning blade scrapes off the residual toner from the photoconductive drum 101, so that the surface of the photoconductive drum 101 is ready for the next cycle of image formation.

Referring to FIG. 2, the poorly charged toner particles may be transferred onto the transfer belt 17 from the photoconductive drums 101 of the image forming sections 31-34 through a small space between consecutive papers being transported through the image forming sections 31-34. The cleaning blade 24 removes toner particles that have been transferred onto the transfer belt 17 when the transfer belt 17 runs in the (f) and (r) directions, and the toner particles is collected as poorly charged toner particles in a toner box 21. Being cleaned in this manner, the transfer belt 17 can be used repeatedly.

recording paper 50 one over the other in registration. The recording paper 50 is further advanced to the fixing unit 40.

Referring to FIG. 6, the recording paper 50 having the toner images of the respective colors enters the fixing unit 40. As the recording paper 50 passes through a fixing point defined between the heat roller 141 and the pressure roller 144, the toner images are fused into the recording paper 50 by pressure and heat.

After fixing, the recording paper 50 is further transported by the transport rollers 45g and 45h and transport rollers 45i and 45j in the (k) direction onto the stacker 46.

Referring to FIG. 4, some toner may remain on the photoconductive drum 101 after transfer. The cleaning blade 105 removes the residual toner from the photoconductive drum 101. The width of the cleaning blade 105 spans across the entire length of the photoconductive drum 101 that rotates about a rotational axis. The cleaning blade 105 is fixed at its base portion to a rigid supporting plate, and is in contact with the circumferential surface of the photoconductive drum 101. As the photoconductive drum 101 rotates, the cleaning blade scrapes off the residual toner from the photoconductive drum 101, so that the surface of the photoconductive drum 101 is ready for the next cycle of image formation.

Referring to FIG. 2, the poorly charged toner particles may be transferred onto the transfer belt 17 from the photoconductive drums 101 of the image forming sections 31-34 through a small space between consecutive papers being transported through the image forming sections 31-34. The cleaning blade 24 removes toner particles that have been transferred onto the transfer belt 17 when the transfer belt 17 runs in the (f) and (r) directions, and the toner particles is collected as poorly charged toner particles in a toner box 21. Being cleaned in this manner, the transfer belt 17 can be used repeatedly.

The transport rollers 45k-45× and guides 41 and 42 transport and guide the recording paper 50. Detailed description of these structural elements has been omitted.

### Toners

The toner according to the invention will be described.

The aforementioned image forming apparatus is a color electrophotographic printer where the printed image is usually given a high gloss. Toners for full color printing are based on a non-cross-linking resin. Therefore, a large amount of toner release agent having a low melting point is added for preventing “offset” on the fixing roller. However, if the toner is subjected to heat treatment for adding an external additive to the toner particles, the toner release agent on the surfaces of the toner particles melts. The melted toner adheres to the structural members including the developing roller 104 causing filming. If the toner particles have a small volume mean particle diameter, the surface areas of the toner particles are large. Thus, in order to ensure toner flowability, a larger amount of external additive is added. As a result, the BET specific surface of the toner increases so that the toner damages the surface of the photoconductive drum 101 in contact with the cleaning blade 105 and builds up there. This causes filming on the photoconductive drum 101 as the cumulative number of printed pages increases.

### Example 1A

TONER A1 was manufactured as follows: The following materials were mixed in a HENSCHEL MIXER: 100 weight parts polyester resin (number average molecular weight Mn=3700, glass transition temperature Tg=62° C.) as a binding resin; 1.0 weight parts salicylic acid complex (BONTRON E-84, available from ORIENT CHEMICAL INDUSTRIES LTD) as a charge control agent; 4.0 weight parts pigment blue 15:3 [ECB-301] (available from DAINICHISEIKA COLOR 6 CHEMICALS MFG. CO., LTD) as a coloring agent; and 5.0 weight parts carnauba wax (powder of carnauba wax #1, available from S. KATO & Co.) as a toner release agent. Then, the mixture is melted, kneaded in a dual extruder, and cooled. The cooled material is then crushed with a cutter mill having a screen of a 2 mm-diameter, and is subsequently pulverized with a dispersion separator (NIHON PNEUMATIC INDUSTRIES LTD). Finally, the pulverized material is classified using a pneumatic separator, thereby obtaining a powder A0 (i.e., toner before an external additive is added to it).

The volume mean particle diameter of the powder A0 was measured with a Coulter's counter (Coulter Multisizer 3 available from BECKMAN COULTER) at an aperture of 100 μm. The measurement was repeated 30,000 times, and the volume mean particle diameter was found to be 6.5 μm. Then, the BET specific surface of the powder A0 was measured as follows: The powder A0 in an amount of 1 g was dried for 3 hours in VACU-PREP 061LB (available from SHIMADZU), and then the BET specific surface was measured in an atmosphere of nitrogen gas by BET multipoint method using TriStar 3000 (available from SHIMADZU). The BET specific surface was found to be 2.25 m²/g.

Hydrophobic silica R972 (average diameter of primary particles=16 nm, Japan Aerosil) in an amount of 2.5 weight parts was added to the powder A0 in an amount of 100 weight parts, and was agitated for 5 minutes at 3200 rpm in a HENSCHEL MIXER of 10 liters capacity. Then, the powder A0 was cooled in the HENSCHEL MIXER and was again agitated for 5 minutes at 3200 rpm in a HENSCHEL MIXER. In this manner, a cycle of “agitation (5 min.)-and-cooling” was repeated 5 times (i.e., a total amount of time for adding an external additive was 25 minutes) to obtain TONER A1. TONER A1 had a volume mean particle diameter of 6.5 μm and a BET specific surface of 2.39 m²/g.

A test printing was performed using the image forming apparatus 10 in FIG. 2 and TONER A1. The printing speed (i.e., circumferential speed of the photoconductive drum 101) was 200 mm/s and the line pressure between the cleaning blade 105 and the photoconductive drum 101 was 1.3 gf/mm. Continuous printing was performed on 30,000 pages of A4 size recording paper (grammage=80 g/m²) in portrait orientation at a printing duty of 5%. Printing duty is the ratio of a total printed area on recording paper to a total printable area on the same recording paper. After the continuous printing operation of 30,000 pages of A4 size recording paper, a solid image was printed and no defect in the printed image was observed and no abnormal condition was observed on the photoconductive drum 101.

### Example 1B

TONER A2 was manufactured in the same manner as TONER A1 except that Hydrophobic silica R972 (average diameter of primary particles=16 nm, Japan Aerosil) in an amount of 2.5 weight parts was added to the powder A0 in an amount of 100 weight parts and a cycle of agitation (5 min.)-and-cooling was repeated 3 times (a total amount of time for adding an external additive was 15 minutes). The resulting TONER A2 had a volume mean particle diameter of 6.5 μm and a BET specific surface of 3.29 m²/g. Continuous printing was performed on 30,000 pages of A4 size paper using TONER A2 in the same manner as in EXAMPLE 1A, and then a solid image was printed. Image defects were not observed in the printed solid image and abnormal conditions were not observed on the photoconductive drum 101.

### Example 1C

TONER A3 was manufactured in the same manner as TONER A1 except that Hydrophobic silica R972 (average diameter of primary particles=16 nm, Japan Aerosil) in an amount of 2.5 weight parts was added to the powder A0 in an amount of 100 weight parts and a cycle of agitation (5 min.)-and-cooling was repeated 2 times (a total amount of time for adding an external additive was 10 minutes). The resulting TONER A3 had a volume mean particle diameter of 6.5 μm and a BET specific surface of 3.70 m²/g. After continuous printing on 30,000 pages of A4 size paper using TONER A3 in the same manner as in EXAMPLE 1A, a solid image was printed. Images of flaws on the photoconductive drum 101 was observed in the printed image. When observation of the surface of the photoconductive drum 101 was made under a scanning electron microscope (SEM), no adhesion of toner was observed but minute groove-like flaws were observed on the photoconductive drum 101.

### Comparison 1A

TONER A4 was manufactured in the same manner as TONER A1 except that Hydrophobic silica R972 (average diameter of primary particles=16 nm, Japan Aerosil) in an amount of 2.5 weight parts was added to the powder A0 in an amount of 100 weight parts and a cycle of agitation (5 min.)-and-cooling was performed one time (a total amount of time for adding an external additive was 5 minutes). The resulting TONER A4 had a volume mean particle diameter of 6.5 μm and a BET specific surface of 4.09 m²/g. After continuous printing on 30,000 pages of A4 size paper using TONER A4 in the same manner as in EXAMPLE 1A, a solid image was printed. Numerous defective areas in which toner is absent from the printed image due to the flaws on the photoconductive drum 101 were observed, the defective area being 0.5 to 5 mm long and 0.1 to 1 mm wide. Flaws corresponding to the defective areas in the printed solid image were observed on the photoconductive drum 101, appearing at intervals of one complete circumference of the photoconductive drum 101.

Also, filming was observed on the photoconductive drum 101. After removing the filming of toner, grooves due to the flaws were observed on the photoconductive drum 101 under the SEM. Adhesion of silica particles and toner was observed in the grooves.

### Example 1D

TONER A5 was manufactured in the same manner as TONER A1 except that Hydrophobic silica R972 (average diameter of primary particles=16 nm, Japan Aerosil) in an amount of 4.5 weight parts was added to the powder A0 in an amount of 100 weight parts and a cycle of agitation (5 min.)-and-cooling was repeated 8 times (i.e., a total amount of time for adding an external additive was 40 minutes). The resulting TONER A5 had a volume mean particle diameter of 6.5 μm and a BET specific surface of 2.42 m²/g. After continuous printing on 30,000 pages of A4 size paper using TONER A5 in the same manner as in EXAMPLE 1A, a solid image was printed. No defect in the printed solid image observed. No abnormal condition was observed on the photoconductive drum 101.

### Example 1E

TONER A6 was manufactured in the same manner as TONER A1 except that Hydrophobic silica R972 (average diameter of primary particles=16 nm, Japan Aerosil) in an amount of 4.5 weight parts was added to the powder A0 in an amount of 100 weight parts, and a cycle of agitation (5 min.)-and-cooling was repeated 5 times (i.e., a total amount of time for adding an external additive was 25 minutes). The resulting TONER A6 had a volume mean particle diameter of 6.5 μm and a BET specific surface of 3.35 m²/g. After continuous printing on 30,000 pages of A4 size paper using TONER A6 in the same manner as in EXAMPLE 1A, a solid image was printed. No defect in the printed solid image was observed. No abnormal condition was observed on the photoconductive drum 101.

### Example 1F

TONER A7 was manufactured in the same manner as TONER A1 except that Hydrophobic silica R972 (average diameter of primary particles=16 nm, Japan Aerosil) in an amount of 4.5 weight parts was added to the powder A0 in an amount of 100 weight parts and a cycle of agitation (5 min.)-and-cooling was repeated 4 times (a total amount of time for adding an external additive was 20 minutes). The resulting TONER A7 had a volume mean particle diameter of 6.5 μm and a BET specific surface of 3.74 m²/g. After continuous printing on 30,000 of A4 size paper using TONER A7 in the same manner as in EXAMPLE 1A, a solid image was printed. The printed solid image did not contain an image of flaws on the photoconductive drum 101 which would otherwise appear at intervals of one complete circumference of the photoconductive drum 101. When observation was made under an SEM, no adhesion of toner was observed but minute groove-like flaws were observed in some areas on the photoconductive drum 101.

### Comparison 1B

TONER A8 was manufactured in the same manner as TONER A1 except that Hydrophobic silica R972 (average diameter of primary particles=16 nm, Japan Aerosil) in an amount of 4.5 weight parts was added to the powder A0 in an amount of 100 weight parts and a cycle of agitation (5 min.)-and-cooling was performed one time (i.e., a total amount of time for adding an external additive was 5 minutes). The resulting TONER A8 had a volume mean particle diameter of 6.5 μm and a BET specific surface of 4.57 m²/g. After continuous printing on 30,000 pages of A4 size paper using TONER A8 in the same manner as in EXAMPLE 1A, a solid image was printed. Numerous images of flaws on the photoconductive drum 101 in which toner is absent from the printed image were observed, the image being 0.5 to 5 mm long and 0.1 to 1 mm wide. Flaws corresponding to the images of flaws in the printed solid image were observed on the photoconductive drum 101 at intervals of one complete circumference of the photoconductive drum 101.

Also, filming was observed on the photoconductive drum 101. The filming of toner that adheres to the grooves due to flaws was removed, and the grooves were observed under the SEM. Adhesion of silica particles and toner was observed.

FIG. 1A illustrates a particle of the toner 110 having a relatively large BET specific surface in which particles of external additive 112 have not entered deep into the toner 110. FIG. 1B illustrates a particle of the toner 110 having a relatively small BET specific surface in which particles of external additive 112 have entered relatively deep into the toner 110.

The results of printing in EXAMPLEs 1A-1F and COMPARISONs 1A-1B reveal that a same amount of external additive causes filming in a larger BET specific surface and not in a smaller BET specific surface. It may be considered that particles of silica (external additive) project outward more from the surface of a toner particle for toner having a large BET specific surface than for toner having a small BET specific surface, tending to scratch the surface of the photoconductive drum 101. Thus, the toner enters scratched grooves (i.e., flaws) caused by the particles of silica, and adheres to the surface of photoconductive drum 101 through repetitive frictional engagement with the cleaning blade 105.

### Comparison 1C

TONER A9 was manufactured in the same manner as TONER A1 except that Hydrophobic silica R972 (average diameter of primary particles=16 nm, Japan Aerosil) in an amount of 5.5 weight parts was added to the powder A0 in an amount of 100 weight parts and a cycle of agitation (5 min.)-and-cooling was repeated 8 times (i.e., a total amount of time for adding an external additive was 40 minutes). The resulting TONER A9 had a volume mean particle diameter of 6.5 μm and a BET specific surface of 4.07 m²/g. After continuous printing on 30,000 pages of A4 size paper using TONER A9 in the same manner as in EXAMPLE 1A, a solid image was printed. Images of flaws formed in the photoconductive drum 101 were observed in the printed solid image, appearing at intervals of one complete circumference of the photoconductive drum 101. Toner entered in flaws formed in the surface of the photoconductive drum 101 was observed, i.e., filming due to toner adhesion to the flaws was observed on the photoconductive drum 101.

### Comparison 1D

TONER A10 was manufactured in the same manner as TONER A1 except that Hydrophobic silica R972 (average diameter of primary particles=16 nm, Japan Aerosil) in an amount of 1.5 weight parts was added to the powder A0 in an amount of 100 weight parts and a cycle of agitation (5 min.)-and-cooling was performed only one time (i.e., a total amount of time for adding an external additive was 5 minutes). The resulting TONER A10 has a volume mean particle diameter of 6.5 μm and a BET specific surface of 3.01 m²/g. After continuous printing on 30,000 pages of A4 size paper using TONER A10 in the same manner as in EXAMPLE 1A, a solid image was printed. The printed solid image was vague and therefore no defect could be detected. When the surface of the photoconductive drum 101 was observed under an SEM, no grooves could be observed. It is considered that the amount of external additive was too small to ensure flowability of toner and therefore toner characteristics were not acceptable.

Table 1 lists the results of EXAMPLEs 1A-1F and COMPARISONs 1A-1D. Symbol “X flaw” denotes that flaws not smaller than 1 mm occurred at intervals of one complete circumference of the photoconductive drum 101 (e.g., about 94.2 mm for a 30 mm diameter of a photoconductive drum) and a corresponding image was observed in the printed image.

Symbol “⊚” denotes that an image of flaws not smaller than 1 mm did not occur in the printed image, appearing at intervals of one complete circumference of the photoconductive drum 101, and adhesion of toner to the photoconductive drum 101 could not be observed under an SEM.

Symbol “◯” denotes that an image of flaws ere not observed in the printed image, appearing at intervals of one complete circumference of the photoconductive drum 101, and adhesion of toner could not be observed under an SEM but grooves were observed in some areas in the photoconductive drum 101.

Symbol “X vague” denotes that an insufficient amount of external additive caused a vague image and therefore an image of flaws in the surface of the photoconductive drum 101 could not be detected.

TABLE 1

| Ex. & | | silica | Ex. Additive | BET | |
|---|---|---|---|---|---|
| Comp. | Toner | wt. parts | time (min) | (m²/g) | Filming |
| Ex. 1A | A1 | 2.5 | 25 | 2.39 | ⊚ |
| Ex. 1B | A2 | 2.5 | 15 | 3.29 | ⊚ |
| Ex. 1C | A3 | 2.5 | 10 | 3.70 | ◯ |
| Ex. 1D | A5 | 4.5 | 40 | 2.42 | ⊚ |
| Ex. 1E | A6 | 4.5 | 25 | 3.35 | ⊚ |
| Ex. 1F | A7 | 4.5 | 20 | 3.74 | ◯ |
| Cmp. 1A | A4 | 2.5 | 5 | 4.09 | X flaw |
| Cmp. 1B | A8 | 4.5 | 5 | 4.57 | X flaw |
| Cmp. 1C | A9 | 5.5 | 40 | 4.07 | X flaw |
| Cmp. 1D | A10 | 1.5 | 5 | 3.01 | X vague |

* The volume mean particle diameter of toners was 6.5 μm
* Powder (toner with no additive) had a BET specific surface = 2.25 m²/g
* silica was R972

The results in Table 1 reveal that poor image quality due to filming formed on the photoconductive drum 101 may be prevented by using toners having a volume mean particle diameter of 6.5 μm, an additive (hydrophobic silica R972 (average diameter of primary particles=16 nm, Japan Aerosil) in an amount of 2.5-4.5 weight parts, and a BET specific surface in the range of 2.39 to 3.74 m²/g. The results in Table 1 also show that the use of a toner having a BET specific surface in the range of 2.39-3.35 m²/g prevents even very small flaws not large enough to affect print quality.

### Examples 1G-1L and Comparisons 1E-1H

TONER B1 to TONER B10 were manufactured in the same manner as in the EXAMPLEs 1A-1F and COMPARISONs 1A-1D except that the powder A0 (toners without additive) have a volume mean particle diameter of 4.5 μm. Table 2 lists the results when test printing was performed. Filming was evaluated in the same manner as in Table 1.

TABLE 2

| Ex. & | | silica | Ex. Additive | BET | |
|---|---|---|---|---|---|
| Comp. | Toner | wt. parts | time (min) | (m²/g) | Filming |
| Ex. 1G | B1 | 2.5 | 25 | 2.45 | ⊚ |
| Ex. 1H | B2 | 2.5 | 15 | 3.30 | ⊚ |
| Ex. 1I | B3 | 2.5 | 10 | 3.83 | ◯ |
| Ex. 1J | B5 | 4.5 | 40 | 2.50 | ⊚ |
| Ex. 1K | B6 | 4.5 | 25 | 3.41 | ⊚ |
| Ex. 1L | B7 | 4.5 | 20 | 3.86 | ◯ |
| Cmp. 1E | B4 | 2.5 | 5 | 4.32 | X flaw |
| Cmp. 1F | B8 | 4.5 | 5 | 5.01 | X flaw |
| Cmp. 1G | B9 | 5.5 | 40 | 4.26 | X flaw |
| Cmp. 1H | B10 | 1.5 | 5 | 3.45 | X vague |

* The volume mean particle diameter toners was 4.5 μm
* Powder (toner with no additive) had a BET specific surface = 2.42 m²/g
* silica was R972

The results in Table 2 reveal that poor image quality due to filming formed on the photoconductive drum 101 may be prevented by using powder A0 (toners with no additive) having a volume mean particle diameter of 4.5 μm, an additive (hydrophobic silica R972 (average diameter of primary particles=16 nm, Japan Aerosil) in an amount of 2.5-4.5 weight parts, and a BET specific surface in the range of 2.45 to 3.86 m²/g. The results in Table 2 also show that the use of a toner having a BET specific surface in the range of 2.45-3.41 m²/g prevents even very small flaws not large enough to affect print quality.

A toner having a volume mean particle diameter of 5.6 μm was also tested. Except for the value of volume mean particle diameter, the test was performed in the same manner as in EXAMPLEs 1A-1L and COMPARISONs 1A-1H. The amount of silica as an external additive added to the toner and the amount of time for which the toners are subjected to the cycle of agitation (5 min.)-and-cooling for adding the external additive were the same as those in EXAMPLEs 1A-1L and COMPARISONs 1A-1H. The resultant values of BET specific surface and printing results were somewhere between those for volume mean particle diameter of 6.5 μm and those for volume mean particle diameter of 4.0 μm.

### Examples 1M-1R and Comparisons 1I-1L

TONER C1 to TONER C10 were manufactured in the same manner as in the EXAMPLEs 1A-1F and COMPARISONs 1A-1D except that toners without additive having a volume mean particle diameter of 6.5 μm and hydrophobic silica R974 (average diameter of primary particles=12 nm, from Japan Aerosil) were used. Table 3 lists the printing results. Filming was evaluated in the same manner as in Table 1.

TABLE 3

| Ex. & | | silica | Ex. Additive | BET | |
|---|---|---|---|---|---|
| Comp. | Toner | wt. parts | time (min) | (m²/g) | Filming |
| Ex. 1M | C1 | 2.5 | 25 | 2.40 | ⊚ |
| Ex. 1N | C2 | 2.5 | 15 | 3.31 | ⊚ |
| Ex. 1O | C3 | 2.5 | 10 | 3.71 | ◯ |
| Ex. 1P | C5 | 4.5 | 40 | 2.46 | ⊚ |
| Ex. 1Q | C6 | 4.5 | 25 | 3.36 | ⊚ |
| Ex. 1R | C7 | 4.5 | 20 | 3.75 | ◯ |
| Cmp. 1I | C4 | 2.5 | 5 | 4.40 | X flaw |
| Cmp. 1J | C8 | 4.5 | 5 | 4.88 | X flaw |
| Cmp. 1K | C9 | 5.5 | 40 | 4.11 | X flaw |
| Cmp. 1L | C10 | 1.5 | 5 | 3.24 | X vague |

* The volume mean particle diameter of toners was 6.5 μm
* Powder (toner with no additive) had a BET specific surface = 2.25 m²/g
* silica was R974

The results in Table 3 reveal that poor image quality due to filming formed on the photoconductive drum 101 may be prevented by using toners having a volume mean particle diameter of 6.5 μm, an additive (hydrophobic silica R974 (average diameter of primary particles=12 nm, Japan Aerosil) in an amount of 2.5-4.5 weight parts, and a BET specific surface in the range of 2.40 to 3.75 m²/g. The results in Table 1 also show that the use of a toner having a BET specific surface in the range of 2.40-3.36 m²/g prevents even very small flaws not large enough to affect print quality.

As described above, filming on the photoconductive drum 101 may be prevented if silica (external additive) in an amount of 2.5 to 4.5 weight parts is added to 100 weight parts toner (A0) having a relatively small volume mean particle diameter in the rage of 4.5 to 6.5 μm such that the resulting toner has a BET specific surface in the range of 2.45 to 3.74 m²/g. More preferably, filming on the photoconductive drum 101 may be prevented by the use of toner having silica in an amount of 2.5 to 4.5 weight parts and a BET specific surface in the range of 2.45-3.35 m²/g.

### Second Embodiment

Referring back to FIG. 2, the cleaning blade 105 is in pressure contact with the photoconductive drum 101. The printing results for a plurality of line pressures applied by the cleaning blade 105 on the photoconductive drum 101 will be described.

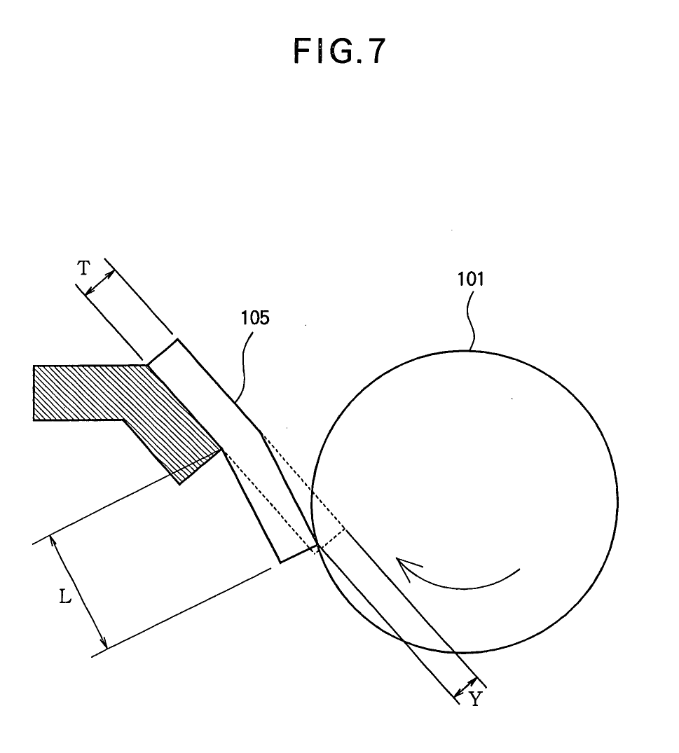

FIG. 7 illustrates how the line pressure applied by the cleaning blade 105 on the photoconductive drum 101 is calculated. Different line pressures were achieved by adjusting the deflection of tip of the cleaning blade 105 and selecting the material of the cleaning blade 105. The line pressure applied by the cleaning blade 105 against the photoconductive drum 101 is given by Equation (1) as follows:

W=E×T³×Y/(4×L³) (1)

W: line pressure applied by the cleaning blade 105 on the photoconductive drum 101
E: Yong's modulus of the cleaning blade 105
T: thickness of the cleaning blade 105
Y: deflection of tip of the cleaning blade 105
L: length of the free portion of the cleaning blade 105

### Example 2A

The cleaning blade 105 was made of urethane #201708 (available from HOKUSHIN KOGYO) having a Young's modulus of 67 kg/cm² and a thickness of T=1.6 mm and a length of free portion of 7 mm. The cleaning blade 105 was set such that the deflection of tip was Y=0.4 mm. Thus, the line pressure was W=0.8 gf/mm. Toner B7 containing 4.5 weight parts silica and having a BET specific surface of 3.86 m²/g was used.

By using the image forming apparatus 10 in FIG. 2 and TONER B7, test printing was performed at a printing speed (i.e., circumferential speed of the photoconductive drum 101) of 300 mm/s. Continuous printing was performed on 30,000 pages of A4 size recording paper (grammage=80 g/m²) in portrait orientation at a printing duty of 5%. Printing duty is the ratio of a total printed area on recording paper to a total printable area on the recording paper. After the continuous printing operation, a solid image was printed. No image of flaws was observed in the printed image which would otherwise appear at intervals of one complete circumference of the photoconductive drum 101. Toner particles did not pass through gaps between the cleaning blade 105 and the photoconductive drum 101 and therefore no streak of toner was adhered to the charging roller 102 in a circumferential direction of the charging roller 102.

### Example 2B

Test printing was performed under the same test condition as in EXAMPLE 2A except that the cleaning blade 105 was positioned such that the deflection of the cleaning blade 105 was Y=1.0 mm and the line pressure was W=2.0 gf/mm. After continuous printing on 30,000 pages of A4 size paper, a solid image was printed. Images of flaws formed in the photoconductive drum 101 were not observed in the printed solid image, which would otherwise appear at intervals of one complete circumference of the photoconductive drum 101. Toner particles did not pass through gaps between the cleaning blade 105 and the photoconductive drum 101 and therefore no streak of toner adhered to the charging roller 102 in a circumferential direction of the charging roller 102.

### Example 2C

Continuous printing was performed on 30,000 pages of A4 size paper under the same test condition as in EXAMPLE 2A except that the cleaning blade 105 was positioned such that the deflection of tip of the cleaning blade 105 was Y=1.2 mm and the line pressure was W=2.4 gf/mm. After printing on 30,000 pages of A4 size paper, a solid image was printed. Images of flaws formed in the photoconductive drum 101 were not observed in the printed solid image, which would otherwise appear at intervals of one complete circumference of the photoconductive drum 101. Toner particles passed through gaps between the cleaning blade 105 and the photoconductive drum 101 and therefore streaks of toner were observed on the charging roller 102 in a circumferential direction of the charging roller 102. However, the amount of toner on the charging roller 102 was too small to affect the charging of the photoconductive drum 101, so that image quality was not adversely affected.

After the test printing, the areas of the cleaning blade 105 in contact with the photoconductive drum 101 were observed under an optical microscope. Wear was observed on the areas. This is apparently due to the fact that the relatively higher line pressure caused wear of the tip portion of the cleaning blade 105.

### Comparison 2A

Continuous Printing on 30,000 pages of A4 size paper was performed under the same condition as in EXAMPLE 2A except that the cleaning blade 105 was positioned such that the deflection of tip of the cleaning blade was Y=1.5 mm and the line pressure was W=3.0 gf/mm. After the continuous printing on 30,000 pages of A4 size paper, a solid image was printed. Images of flaws formed on the surface of the photoconductive drum 101 were observed in the printed image, appearing at intervals of one complete circumference of the photoconductive drum 101. Flaws were observed in the surface of the photoconductive drum 101 under an SEM. Wear was also noted in an area of the cleaning blade 105 in contact with the photoconductive drum 101 under an optical microscope. Toner particles passed through gaps between the cleaning blade 105 and the photoconductive drum 101 and therefore streaks of toner were observed on the charging roller 102 in a circumferential direction of the charging roller 102. The streaks caused non-uniform charging of the photoconductive drum 101 leading to variation of image density.

This is apparently due to the fact that the cleaning blade 105 exerts a relatively high line pressure on the toner particles such that the toner particles are pressed strongly against the surface of the photoconductive drum 101. Thus, the toner particles tend to damage the surface of the photoconductive drum 101 while also causing the tip portion of the cleaning blade 105 to wear out.

### Comparison 2B

Test printing was performed under the same test condition as in EXAMPLE 2A except that the cleaning blade 105 was positioned such that the deflection of tip of the cleaning blade 105 was Y=0.2 mm and the line pressure was W=0.4 gf/mm. The toner particles passed through gaps that exist between the cleaning blade 105 and the photoconductive drum 101 substantially across the entire width of the cleaning blade 105, and therefore printing could not be continued. This is apparently due to the fact that the line pressure was too low to scrape off the residual toner from the photoconductive drum 101.

### Examples 2D-2F and Comparisons 2C-2D

Continuous printing was performed in the same manner as in EXAMPLEs 2A-2C and COMPARISONs 2A-2B by using Toner B3 (2.5 weight parts silica is added to 100 weight parts powder A0 (i.e., toner before an external additive is added) and a BET specific surface=3.83 m²/g). The results were much the same as those in EXAMPLEs 2A-2C and COMPARISONs 2A-2B. In other words, there was no significant difference in print quality between toner B3 and toner B7.

Table 4 lists the results of EXAMPLEs 2A-2F and COMPARISONs 2A-2D.

Symbol “◯” indicates that filming did not occur on the photoconductive drum 101, non-uniform charging of the photoconductive drum 101 did not occur, and the streaks of toner did not appear on the charging roller 102 that would otherwise occur due to poor cleaning, and therefore images of flaws in the photoconductive drum 101 were not observed in the printed solid image after the continuous printing on 30,000 pages of A4 size paper.

Symbol “X” denotes that after the continuous printing on 30,000 pages of A4 size paper, images of flaws on the photoconductive drum 101 appeared in the printed solid image and image quality was also poor due to the streaks of toner adhered to the charging roller.

Symbol “X not acceptable” indicates that printing could not be performed due to poor cleaning results.

Symbol “Δ” indicates that after the continuous printing on 30,000 pages of A4 size paper, an image of flaws due to filming formed on the photoconductive drum 101 was not observed, and the streaks of toner appeared on the charging roller due to poor cleaning, but poor image was not observed in the printed solid image, which would otherwise result from poor charging of the photoconductive drum.

TABLE 4

| | | silica | | | | |
|---|---|---|---|---|---|---|
| Ex. & | | wt. | BET | Y | W | |
| Comp. | Toner | parts | (m²/g) | (mm) | (gf/mm) | results |
| Ex. 2A | B7 | 4.5 | 3.86 | 0.4 | 0.8 | ◯ |
| Ex. 2B | B7 | 4.5 | 3.86 | 1.0 | 2.0 | ◯ |
| Ex. 2C | B7 | 4.5 | 3.86 | 1.2 | 2.4 | Δ |
| Cmp. 2A | B7 | 4.5 | 3.86 | 1.5 | 3.0 | X |
| Cmp. 2B | B7 | 4.5 | 3.86 | 0.2 | 0.4 | X not acceptable |
| Ex. 2D | B3 | 2.5 | 3.83 | 0.4 | 0.8 | ◯ |
| Ex. 2E | B3 | 2.5 | 3.83 | 1.0 | 2.0 | ◯ |
| Ex. 2F | B3 | 2.5 | 3.83 | 1.2 | 2.4 | Δ |
| Cmp. 2C | B3 | 2.5 | 3.83 | 1.5 | 3.0 | X |
| Cmp. 2D | B3 | 2.5 | 3.83 | 0.2 | 0.4 | X not acceptable |

The volume mean particle diameter of toners was 4.5 μm
printing speed was 300 mm/s

### Example 2G

Continuous printing was performed in the same manner as in EXAMPLE 2A by using Toner A7 (4.5 weight parts silica is added and a BET specific surface=3.74 m²/g). A solid image was printed after continuous printing on 30,000 pages of A4 size paper. Images of flaws formed on the surface of the photoconductive drum 101 were not observed in the solid image, which would otherwise appear at intervals of one complete circumference of the photoconductive drum 101. Toner particles did not pass through gaps between the cleaning blade 105 and the photoconductive drum 101, and therefore streaks of toner were not observed on the charging roller 102 in a circumferential direction of the charging roller 101.

### Example 2H

Continuous printing was performed on 30,000 pages of A4 size paper in the same manner as in EXAMPLE 2B by using Toner A7 (4.5 weight parts silica is added and a BET specific surface=3.74 m²/g). A solid image was printed after the continuous printing on 30,000 pages of A4 size paper. Images of flaws formed on the surface of the photoconductive drum 101 were not observed in the solid image, which would otherwise appear at intervals of one complete circumference of the photoconductive drum 101. Toner particles did not pass through gaps between the cleaning blade 105 and the photoconductive drum 101, and therefore streaks of toner were not observed on the charging roller 102 in a circumferential direction of the charging roller 102.

### Example 2I

Continuous printing was performed on 30,000 pages of A4 size paper was performed in the same manner as in EXAMPLE 2C by using Toner A7 (4.5 weight parts silica is added and a BET specific surface=3.74 m²/g). A solid image was printed after the continuous printing of 30,000 pages of A4 size paper. Images of flaws formed on the surface of the photoconductive drum 101 were not observed in the solid image, which would otherwise appear at intervals of one complete circumference of the photoconductive drum 101. Toner particles did not pass through gaps between the cleaning blade 105 and the photoconductive drum 101, and therefore streaks of toner were not observed on the charging roller 102 in a circumferential direction of the charging roller 102.

After the test printing, the areas of the cleaning blade 105 in contact with the photoconductive drum 101 were observed under an optical microscope. Wear similar to those in EXAMPLE 2C was observed. This is apparently due to the fact that while the wear of the cleaning blade 105 at its tip portion was substantially the same as that in EXAMPLE 2C, the volume mean particle diameter (6.5 μm) of TONER A7 relatively larger than that (4.5 μm) of TONER B7 of EXAMPLE 2C was more effective in cleaning and therefore prevented poor cleaning.

### Comparison 2E

Test printing was performed in the same manner as in COMPARISON 2A by using Toner A7 (4.5 weight parts silica is added and a BET specific surface=3.74 m²/g). A solid image was printed after continuous printing of 30,000 pages on A4 size paper. Images of flaws formed on the surface of the photoconductive drum 101 were observed in the solid image, appearing at intervals of one complete circumference of the photoconductive drum 101. The flaws on the photoconductive drum 101 were observed under an SEM. Wear on the cleaning blade 105 was observed under an optical microscope. Toner particles passed through gaps between the cleaning blade 105 and the photoconductive drum 101, and therefore streaks of toner were observed on the charging roller 102 in a circumferential direction of the charging roller 102. As a result, the photoconductive drum 101 was not charged sufficiently, causing variation of density in a printed image.

This is apparently due to the fact that the cleaning blade 105 exerts a relatively high line pressure on the toner particles such that the toner particles are pressed strongly against the surface of the photoconductive drum 101. Thus, the toner particles damage the surface of the photoconductive drum 101 while also causing the tip portion of the cleaning blade 105 to wear out.

### Comparison F

Continuous printing was performed on 30,000 pages of A4 size paper in the same manner as in COMPARISON 2B by using Toner A7 (4.5 weight parts silica is added and a BET specific surface=3.74 m²/g). A solid image was printed after the continuous printing of 30,000 pages. The toner particles passed through gaps that exist between the cleaning blade 105 and the photoconductive drum 101 across the entire width of the cleaning blade 105, and therefore printing could not be carried out. This is apparently due to the fact that the line pressure was too low to scrape off the residual toner from the photoconductive drum 101.

### Examples 2J-2L and Comparisons 2G-2H

Test printing was performed in the same manner as in EXAMPLEs 2G-2I and COMPARISONs 2E-2F by using Toner A3 (2.5 weight parts silica is added and a BET specific surface=3.70 m²/g). The results were much the same as those in EXAMPLEs 2G-2I and COMPARISONs 2E-2F. In other words, there was no significant difference in printed image between Toner B3 (EXAMPLEs 2J-2L and COMPARISONs 2G-2H) and Toner A7 (EXAMPLEs 2G-2I and COMPARISONs 2E-2F).

Table 5 lists the results of EXAMPLE 2G-2L and COMPARISONs 2E-2H. Evaluation was made in the same manner as in Table 4.

TABLE 5

| | | silica | | | | |
|---|---|---|---|---|---|---|
| Ex. & | | wt. | BET | Y | W | |
| Comp. | Toner | parts | (m²/g) | (mm) | (gf/mm) | results |
| Ex. 2G | A7 | 4.5 | 3.74 | 0.4 | 0.8 | ◯ |
| Ex. 2H | A7 | 4.5 | 3.74 | 1.0 | 2.0 | ◯ |
| Ex. 2I | A7 | 4.5 | 3.74 | 1.2 | 2.4 | ◯ |
| Cmp. 2E | A7 | 4.5 | 3.74 | 1.5 | 3.0 | X |
| Cmp. 2F | A7 | 4.5 | 3.74 | 0.2 | 0.4 | X not acceptable |
| Ex. 2J | A3 | 2.5 | 3.70 | 0.4 | 0.8 | ◯ |
| Ex. 2K | A3 | 2.5 | 3.70 | 1.0 | 2.0 | ◯ |
| Ex. 2L | A3 | 2.5 | 3.70 | 1.2 | 2.4 | ◯ |
| Cmp. 2G | A3 | 2.5 | 3.70 | 1.5 | 3.0 | X |
| Cmp. 2H | A3 | 2.5 | 3.70 | 0.2 | 0.4 | X not acceptable |

The volume mean particle diameter of toners was 6.5 μm
printing speed was 300 mm/s

By using Toners B1, B2, B5, and B6, continuous printing was performed on 30,000 pages of A4 size paper in the same manner as in EXAMPLEs 2A-2C and COMPARISONs 2A-2B in which Toner B7 was used. A solid image was printed after the printing on 30,000 pages of A4 size paper. For the line pressure in the range of W=0.4-2.4 gf/mm, the results were the same as those in which Toner B7 was used. For W=3.0 gf/mm, images of flaws formed on the surface of the photoconductive drum 101 were not observed in the solid image, which would otherwise appear at intervals of one complete circumference of the photoconductive drum 101. No adhesion of toner was observed on the photoconductive drum 101 under an SEM, but minute groove-like flaws were observed. Poor cleaning occurred.

By using Toners A1, A2, A5, and A6, continuous printing was performed on 30,000 pages of A4 size paper in the same manner as in EXAMPLEs 2G-2I and COMPARISONs 2E-2F in which Toner A7 was used. A solid image was printed after the continuous printing of 30,000 pages. For line pressures W=0.4 to 2.4 gf/mm, the results were much the same as those in EXAMPLEs 2G-2I and COMPARISONs 2E-2F in which Toner A7 was used. However, for a line pressure W=3.0 gf/mm, images of flaws formed on the surface of the photoconductive drum 101 were not observed in the solid image, which would other wise appear at intervals of one complete circumference of the photoconductive drum 101. Toner adhesion to the photoconductive drum 101 was not observed under an SEM, but minute groove-like flaws were observed in some areas of the surface of the photoconductive drum 101. Poor cleaning occurred.

Further, using TONER B7, B3, A7, and, A3, continuous printing was performed under the same printing conditions as EXAMPLEs 2A-2C, EXAMPLEs 2D and 2E, EXAMPLEs 2G-2I, and EXAMPLEs 2J-2L, respectively, except that printing speeds were 250 mm/s, 200 mm/s, 150 mm/s, 100 mm/s, and 50 mm/s for each of TONER B7, B3, A7, and, A3. For line pressures in the rage of 0.8-2.4 gf/mm, none of filming, poor image, and poor cleaning occurred.

From the above-described test results, stable continuous printing may be achieved by meeting the following conditions without filming and/or poor image quality due to poor cleaning:
(1) The printing speed is in the range of 50-300 mm/s.
(2) The volume mean particle diameter of toner is in the range of 4.5-6.5 μm.
(3) The BET specific surface is in the range of 2.45 to 3.74 m²/g when an external additive (silica) is in the range of 2.5 to 4.5 weight parts.
(4) The line pressure of the cleaning blade is in the range of 0.8-2.4 gf/mm.

The BET specific surface of toner is preferably in the range of 2.45-3.35 m²/g. The line pressure of the cleaning blade is preferably in the range of 0.8-2.0 gf/mm. A combination of a BET specific surface of toner in the range of 2.45-3.35 m²/g and a line pressure of the cleaning blade in the range of 0.8-2.0 gf/mm is still more preferable.

### Third Embodiment

The average roundness of Toner B7 in EXAMPLE 2C and Toner B3 in EXAMPLE 2F was measured with a flow particle image analyzer (FPIA-2000, available from TOA medical electronics. The average roundness of Toner B7 and Toner B3 is 0.940. Roundness is given by Equation (2) as follows:

Roundness=2πr/L (2)

where 2πr is the circumference of a circle having an area equal to the projected area of the bi-level image of a toner particle when the toner particle is projected onto a two-dimensional plane, and L is the peripheral length of the toner particle.

Roundness indicates how close to a perfect sphere a toner particle is. If a toner particle is a perfect sphere, the roundness of the toner particle is 1.00. The more a toner particle deviates from a sphere, the smaller the roundness is.

In the third embodiment, the cleaning blade 105 was positioned such that the line pressure was W=2.4 gf/mm just as in EXAMPLEs 2C and 2F. Test printing was performed using toners having different values of roundness.

### Example 3A

The line pressure was set to W=2.4 gf/mm. Toner B7 (the amount of silica=4.5 weight parts and BET specific surface=3.86 m²/g) having an average roundness of 0.940 was used.

Under the aforementioned conditions, test printing was performed using the image forming apparatus 10 in FIG. 2.

Continuous printing was performed on 40,000 pages of A4 size paper (grammage=80 g/m²) in portrait orientation. The printing duty was 5% and the printing speed was 300 mm/s. After printing 30,000 pages, a solid image was printed. After printing 40,000 pages, a solid image was printed.

After printing 30,000 pages, the print results were the same as those in EXAMPLE 2C. After printing 40,000 pages, some streaks of toner were observed on the charging roller 102 but poor image (streaks in a printed solid image), which could occur due to poor charging of the photoconductive drum 101, did not occur. Poor images due to flaws formed on the photoconductive drum 101 were not observed. Other image defects due to low roundness did not occur. Toner particles having low roundness are not attracted straight by the Coulomb force but are pulled by surroundings causing dust-like print results in the background of the image.

### Example 3B

Toner D1 (4.5 weight parts silica, BET specific surface=3.85 m²/g) having an average roundness of 0.935 was manufactured by adjusting the conditions for pulverization and classification. Test printing was performed under the same conditions as EXAMPLE 3A except that Toner D1 was used in place of Toner B7. After printing 40,000 pages on A4 size paper, no streak of toner was observed on the charging roller 102. No defective image (streaks in printed image) occurred which otherwise might occur due to poor charging of the photoconductive drum and other causes.

### Comparison 3A

Toner D2 (4.5 weight parts silica, BET specific surface=3.83 m²/g) having an average roundness of 0.945 was manufactured by adjusting the conditions for pulverization and classification. Test printing was performed under the same conditions as EXAMPLE 3A except that Toner D2 was used in place of Toner B7. After printing 30,000 pages on A4 size paper, streaks of toner were observed on the charging roller 102. After printing 40,000 pages on A4 size paper, poor images (streaks in printed solid images) occurred due to adhesion of toner to the charging roller (i.e., poor charging of the photoconductive drum 102). Poor images due to flaws formed in the photoconductive drum 101 and other causes did not occur.

### Comparison 3B

Toner D3 (4.5 weight parts silica, BET specific surface=3.85 m²/g) having an average roundness of 0.950 was manufactured by adjusting the conditions for pulverization and classification. Test printing was performed under the same conditions as EXAMPLE 3A except that Toner D3 was used in place of Toner B7. After printing 30,000 pages, streaks of toner were observed on the charging roller 102. Poor images (streaks in printed solid images) occurred due to adhesion of toner to the charging roller (i.e., poor charging of the photoconductive drum) 102. Poor images due to flaws formed in the photoconductive drum 101 and other causes did not occur.

### Example 3C

Toner D4 (4.5 weight parts silica, BET specific surface=3.86 m²/g) having an average roundness of 0.900 was manufactured by adjusting the conditions for pulverization and classification. Test printing was performed under the same conditions as in EXAMPLE 3A except that Toner D4 was used in place of Toner B7. After printing 40,000 pages, poor images (streaks in printed solid images) due to adhesion of toner to the charging roller (i.e., poor charging of the photoconductive drum) 102 did not occur. Poor images due to flaws in the photoconductive drum 101 and other causes did not occur.

### Comparison 3C

Toner D5 (4.5 weight parts silica, BET specific surface=3.86 m²/g) having an average roundness of 0.895 was manufactured by adjusting conditions for pulverization and classification.

Printing was performed under the same conditions as in EXAMPLE 3A except that Toner D5 was used in place of Toner B7. After printing 40,000 pages, poor images (streaks in printed images) due to adhesion of toner to the charging roller (i.e., poor charging of the photoconductive drum) 102 did not occur. Poor images due to flaws formed in the photoconductive drum 101 and other causes did not occur but toner was missing from some areas in a printed solid image. This is apparently due to the fact that the low roundness prevented the transfer voltage from being applied uniformly to the entire layer of toner formed on the photoconductive drum 101 and therefore the toner image was not transferred uniformly and thoroughly to the print medium.

### Examples 3D-3F and Comparisons 3D-3F

In the same manner as in EXAMPLEs 3B and 3C and COMPARISONs 3A-3C, Toners D6-D10 (2.5 weight parts silica, BET specific surface=3.81, 3.8, 3.82, 3.83, 3.83 m²/g) having an average roundness of 0.935, 0.945, 0.950, 0.900, and 0.895 were manufactured by adjusting conditions for pulverization and classification.

Test printing was performed in EXAMPLEs 3D, 3E, and 3F by using Toners B3, D6, and D9, respectively.

Printing was performed in COMPARISONs 3D, 3E, and 3F by using D7, D8, and D10, respectively.

Table 6 lists the results of EXAMPLEs 3A-3F and COMPARISONs 3A-3F.

In EXAMPLE 3D, after printing on 40,000 pages of A4 size paper, adhesion of Toner B to the charging roller 102 occurred to some degree but did not cause poor charging of photoconductive drum 101 and therefore no poor image occurred due to the poor charging of photoconductive drum 101. Also, poor images due to flaws formed in the surface of the photoconductive drum 101 and other causes did not occur.

The results in EXAMPLEs 3E-3F and COMPARISONs 3D-3F were much the same as those in EXAMPLEs 3B-3C and COMPARISONs 3A-3B.

Symbol “◯” indicates that adhesion of toner to the charging roller 102 was not observed and poor images due to poor charging of the photoconductive drum 101 resulting from adhesion of toner to the charging roller 102 did not occur.

Symbol “Δ” indicates that adhesion of toner to the charging roller 102 was observed but was not enough to cause poor charging of the photoconductive drum 101 that in turn causes poor images.

Symbol “X” indicates that adhesion of toner to the charging roller 102 was enough to cause poor charging of the photoconductive drum 101 that in turn causes poor images.

For evaluation of image quality, symbol “0” indicates that toner was not absent from some areas in a printed image, and symbol “X” indicates that toner was absent from some areas in a printed image.

TABLE 6

| | | | | | adhesion of | | |
|---|---|---|---|---|---|---|---|
| Ex. & | | average | silica | | toner | | image |
| Comp. | Toner | roundness | wt. parts | BET (m²/g) | 30k pages | 40k pages | quality |
| Ex. 3A | B7 | 0.940 | 4.5 | 3.86 | Δ | Δ | ◯ |
| Ex. 3B | D1 | 0.935 | 4.5 | 3.85 | ◯ | ◯ | ◯ |
| Cmp. 3A | D2 | 0.945 | 4.5 | 3.83 | Δ | X | ◯ |
| Cmp. 3B | D3 | 0.950 | 4.5 | 3.85 | X | X | ◯ |
| Ex. 3C | D4 | 0.900 | 4.5 | 3.86 | ◯ | ◯ | ◯ |
| Cmp. 3C | D5 | 0.895 | 4.5 | 3.86 | ◯ | ◯ | X |
| Ex. 3D | B3 | 0.940 | 2.5 | 3.83 | Δ | Δ | ◯ |
| Ex. 3E | D6 | 0.935 | 2.5 | 3.81 | ◯ | ◯ | ◯ |
| Cmp. 3D | D7 | 0.945 | 2.5 | 3.80 | Δ | X | ◯ |
| Cmp. 3E | D8 | 0.950 | 2.5 | 3.82 | X | X | ◯ |
| Ex. 3F | D9 | 0.900 | 2.5 | 3.83 | ◯ | ◯ | ◯ |
| Cmp. 3F | D10 | 0.895 | 2.5 | 3.83 | ◯ | ◯ | X |

The volume mean particle diameter of toners was 4.5 μm
Printing speed was 300 mm/s
Line pressure was 2.4 gf/mm

The results in Table 6 reveal that toner having an average roundness in the range of 0.900-0.940 prevents poor images due to adhesion of toner to the charging roller 105 resulting from poor cleaning, and prevents toner from being absent from some areas in a printed image. The results in Table 6 also reveal that toner having an average roundness in the range of 0.900-0.935 prevents the toner from adhering to the charging roller 102 due to poor cleaning.

With the following printing conditions (1)-(5), toner having an average roundness in the range of 0.900-0.940 prevents poor image quality due to absence of toner from some areas in a printed solid image that results from poor transfer, and to adhesion of toner to the charging roller 102 that results from poor cleaning:
(1) The line pressure was W=2.0 gf/mm or 0.8 gf/mm,
(2) The printing speed was 250 mm/s, 200 mm/s, 150 mm/s, 100 mm/s, or 50 mm/s,
(3) The volume mean particle diameter was in the range of 4.5-6.5 μm,
(4) Silica in an amount of 2.5-4.5 weight parts was added to 100 weight parts toner, and
(5) The BET specific surface was in the range of 2.45-3.74 m²/g.

With the above conditions (1)-(5), it was confirmed that toner having an average roundness in the range of 0.900-0.940 minimizes the chance of poor image quality occurring due to adhesion of toner to the charging roller that results from poor cleaning. Toner having an average roundness in the range of 0.900-0.935 prevents even adhesion of toner to the charging roller that results from poor cleaning.

The binding resin for the toners according to the present invention is preferably polyester resins, styrene acrylic resins, epoxy resins, or stylene butadiene resins.

Known types of toner release agents may be used in the present invention. Toner release agents used in the present invention includes copolymer including low molecular weight polyethylene, low molecular weight polypropylene, and olefin; alphatic hydrocarbon waxes including micro crystalline wax, and paraffin wax; oxides of alphatic hydrocarbon waxes or block copolymer of alphatic hydrocarbon waxes; waxes carnauba wax and montanic acid ester wax whose major ingredient is fatty ester; and wax such as deoxidized carnauba obtained by deoxidizing part of or all of fatty esters.

The toner release agent in an amount of 0.1-15 weight parts (more preferably 0.5-12 weight parts) should be added to 100 weight part of binder resin. A plurality of waxes may be preferably added.

The coloring agents used in the toner according to the present invention may employ conventional dyes and pigments as a coloring agent for black toner and color toners. The coloring agents include carbon black, phthalocyanine blue, permanent brown FG, brilliant first scarlet, pigment green B, rhodamine-B-base, solvent red 149, solvent red 49, pigment blue 15:3, solvent blue 35, quinacridone, carmine 6B, and disazo yellow. The coloring agent should be in an amount of 2-25 weight parts for the binding resin in an amount of 100 weight parts.

The following additives may be added to the toner: charge control agent, conductivity controller, loading pigment, reinforcing filler such as fibrous material, antioxidant, antioxidant, fluidity adding agent, cleaning aid. In order to improve environmental stability, charge stability, developability, flowability, and shelf stability, inorganic fine powder may be added to the toner.

The photoconductive drum used in the present invention may include an inorganic photoconductive drum in which an electrically conductive core formed of, for example, aluminum is covered with a photoconductive layer such as selenium or amorphous silicone. Alternatively, the photoconductive drum may be an organic photoconductive drum in which an electrically conductive core formed of, for example, aluminum is covered with an inorganic layer that contains a charge generation agent and/or a charge transport agent dispersed in a binding resin.

The cleaning blade used in the present invention may be formed of a resilient material such as urethane rubber, epoxy rubber, acrylic rubber, fluoroplastic, nitrile-butadiene rubber (NBR), stylene-butadiene rubber (SBR), isoprene rubber, or polybutadiene rubber.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

1. A developing unit, comprising:
an image bearing body including a surface that runs at a linear speed in the range of 50-300 mm/s;
a charging member that charges a surface of said image bearing body;
a developer holding section that holds a developer;
a developer bearing body that supplies the developer to an electrostatic latent image formed on the image bearing body to develop the electrostatic latent image into a visible image;
a resilient member disposed upstream of said charging member with respect to rotation of said image bearing body and downstream of said developer bearing body, said resilient member being in resilient contact with said image bearing body such that said resilient member exerts a line pressure in the range of 0.8-2.4 gf/mm on said image bearing body;
wherein the developer comprises an external additive, the external additive being in an amount of 2.5 to 4.5 weight parts before it is deposited to the surface of the developer, and the developer before being in an amount of 100 weight parts before the additive is deposited to the surface of the developer;
wherein the developer before an external additive is added thereto has an average volume mean particle diameter in the range of 4.5 to 6.5 μm and a BET specific surface in the range of 2.45 to 3.74 m²/g; and
wherein the additive before it is added to the developer is in an amount of 2.5 to 4.5 weight parts based on 100 weight parts developer before the additive is added thereto.

2. The developing unit according to claim 1, wherein the BET specific surface is in the range of 2.45 to 3.35 m²/g.

3. The developing unit according to claim 1, wherein the line pressure is in the range of 0.8-2.0 gf/mm.

4. The developing unit according to claim 1, wherein the external additive is silica.

5. The developing unit according to claim 2, wherein the external additive is silica.

6. The developing unit according to claim 3, wherein the external additive is silica.

7. The developing unit according to claim 1, wherein the developer has an average roundness in the range of 0.900 to 0.940.

8. The developing unit according to claim 2, wherein the developer has an average roundness in the range of 0.900 to 0.940.

9. The developing unit according to claim 3, wherein the developer has an average roundness in the range of 0.900 to 0.940.

10. The developing unit according to claim 4, wherein the developer has an average roundness in the range of 0.900 to 0.940.

11. The developing unit according to claim 5, wherein the average roundness is in the range of 0.900 to 0.935.

12. The developing unit according to claim 1, wherein the image bearing body is in contact with the developer bearing body.

13. The developing unit according to claim 2, wherein the image bearing body is in contact with the developer bearing body.

14. The developing unit according to claim 3, wherein the image bearing body is in contact with the developer bearing body.

15. An image forming apparatus incorporating the developing unit according to claim 1, wherein the image forming apparatus further comprises:
a transfer section that transfers the visible image onto a recording medium; and
a fixing section that fixes the visible image into a permanent image.

16. An image forming apparatus incorporating the developing unit according to claim 2, wherein the image forming apparatus further comprises:
a transfer section that transfers the visible image onto a recording medium; and
a fixing section that fixes the visible image into a permanent image.

17. An image forming apparatus incorporating the developing unit according to claim 3, wherein the image forming apparatus further comprises:
a transfer section that transfers the visible image onto a recording medium; and
a fixing section that fixes the visible image into a permanent image.

18. An image forming apparatus incorporating the developing unit according to claim 4, wherein the image forming apparatus further comprises:
a transfer section that transfers the visible image onto a recording medium; and
a fixing section that fixes the visible image into a permanent image.

19. An image forming apparatus incorporating the developing unit according to claim 5, wherein the image forming apparatus further comprises:
a transfer section that transfers the visible image onto a recording medium; and
a fixing section that fixes the visible image into a permanent image.

20. An image forming apparatus incorporating the developing unit according to claim 6, wherein the image forming apparatus further comprises:
a transfer section that transfers the visible image onto a recording medium; and
a fixing section that fixes the visible image into a permanent image.

21. An image forming apparatus incorporating the developing unit according to claim 7, wherein the image forming apparatus further comprises:
a transfer section that transfers the visible image onto a recording medium; and
a fixing section that fixes the visible image into a permanent image.
